(19) United States
(12) Patent Application Publication
(10) Pub. No.: US 2018/0322542 A1
(43) Pub. Date: Nov. 8, 2018

(54) COMPUTER-IMPLEMENTED METHOD FOR CROWD FUNDRAISING

(71) Applicant: George Stantchev, Phoenix, AZ (US)

(72) Inventor: George Stantchev, Phoenix, AZ (US)

(21) Appl. No.: 15/586,774

(22) Filed: May 4, 2017

(51) Int. Cl. G06Q 30/02; G06Q 10/06; G06Q 50/00; G06Q 10/10

(52) U.S. Cl. CPC G06Q 30/0279; G06Q 10/0631; G06Q 10/10; G06Q 30/0283; G06Q 50/01

(57) ABSTRACT

The invention is a computer-implemented method for crowd fundraising. The method includes: a transmission server as a part of a crowd funding platform, wherein the transmission server has a microprocessor and a memory to store user related information. The microprocessor: receives information associated with multiple crowdsourcing ideas; displays such information and ideas on a crowd funding platform. If the crowdsourcing idea reaches a target amount of the crowdsourcing, the crowdsourcing idea turns into a crowd funding project. The microprocessor further distributes information associated with the crowd funding project to at least one on the crowd funding platform, wherein one or more manufactures or service providers are invited to join and make the project. Assign one manufacturer or service provider to the project. Receives one or more contributions associated with the project. Calculates a total amount of one or more of contributions. Determining if the total amount is equal to or exceeds the target amount and calculates the total amount that needs to be transferred to one manufacture or service provider.

### CROSS-REFERENCE TO RELATED APPLICATIONS

The present application is a non-provisional of, and claims priority to, U.S. Provisional Patent Application Ser. No. 63/331,959, filed May 4, 2016, and titled “REVERSE CROWDFUNDING”, which is herein incorporated by reference in its entirety.

### BACKGROUND

Crowd funding, or online crowd funding is a new alternative financing for individuals and startup companies. Different from the traditional way of funding, such as banks, venture capitalists, or angel investors (which are limited to accredited investors), crowd funding could let the early stage companies or startups to raise money via internet worldwide. Those startup companies could get funding from the public for their innovative ideas instead of more sophisticated and more demanding accredited investors.

Usually, crowd funding would launch on a platform (i.e. website), and people would have published their projects on the platform for attracting potential investors. The project could be products or service or might be merely an idea or prototype. Any investors could contribute and fund any project they are interested in. Once the project gathers enough funds, the project could carry out. Most projects promise these investors (called backer) a pre-order transaction and those backers expect to receive the product or service in exchange of the invested capital. Once the product is done or the service is launched, the product or service would be delivered to the investors/backers.

However, high percentage of projects fail due lack of proper investment. The abovementioned platform does not require background check or guarantees; therefore, it would be hard for the investors to recognize which idea would be safe to invest in. Most of the startup companies are not experienced in manufacturing, marketing and business operation. They might have good idea but a lack of experience and limited budget or time, therefore could lead to a failure. In some circumstances, the investors would stay away from such startups, since the only way for the investors to evaluate them would be their website.

Accordingly, there exist a need of widely open crowd funding platform that creates the connection of trust between the inventor, investor and manufacturer and could facilitate and insure that the idea will get to market and turn into a product or service with highest chance of success. Also, there is a need for people with ideas to find suitable manufactures to make their products. There is also a need for mitigating the risk of new products to market utilizing a crowd funding method.

### SUMMARY

One objective of the present invention is to provide a method or platform that could match and cooperate with the idea providers, manufacturers and the investors.

Other objective of the present invention is to increase the ability of projects to be funded.

Another objective of the present invention is to ensure that the idea will turn into a product or service.

One objective of the present invention to help people with ideas to find manufactures for their products.

Present invention allows teams that are capable of bringing the ideas to market to build the actual product or service. These teams will browse the ideas submitted by the inventors, estimate the manufacturability of the idea and bid for the idea based on how much funding each idea have raised as well as how many people are interested in the idea.

The method is related to crowd fundraising. In the preferred embodiment, the crowd funding method or system is operated on or connected to a crowd fundraising platform.

This invention relates generally to a crowd funding and in particular to platforms for providing qualified investors with diligence and analyses of startup companies and efficiently aggregating funding using automated process.

### BRIEF DESCRIPTION OF THE DRAWINGS

The accompanying drawings are incorporated in and constitute a part of this specification and, together with the description, explain the advantages and principles of the invention. In the drawings,

FIG. 1 is a flow chart illustrating a method for the crowd funding, in accordance with certain embodiments.

FIG. 2 is a block diagram showing a crowd funding platform, in accordance with an example embodiment.

FIG. 3 is a block diagram showing how the web/cloud also called transmission server interacts with different users, in accordance with certain embodiment of the invention.

### DETAILED DESCRIPTION OF THE PREFERRED EMBODIMENTS

The foregoing description of the embodiments of the invention has been presented for the purpose of illustration; it is not intended to be exhaustive or to limit the invention to the exact form disclosed. Person skilled in the relevant art can appreciate that many modifications and variations are possible in light of the above disclosure.

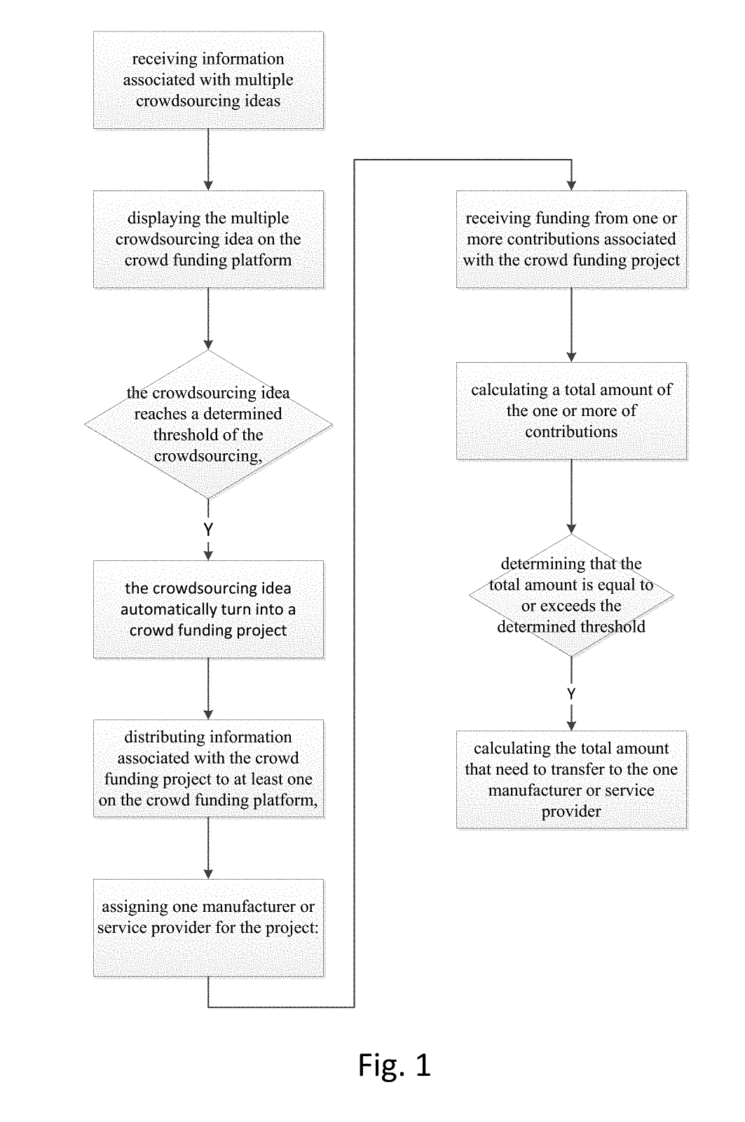

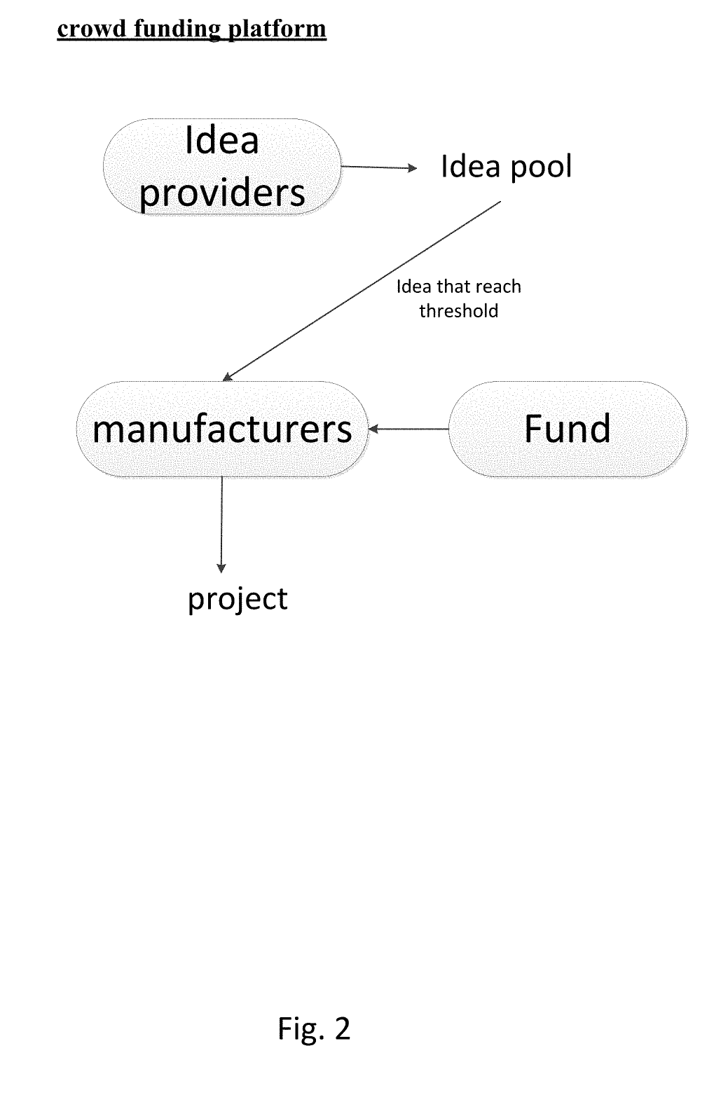

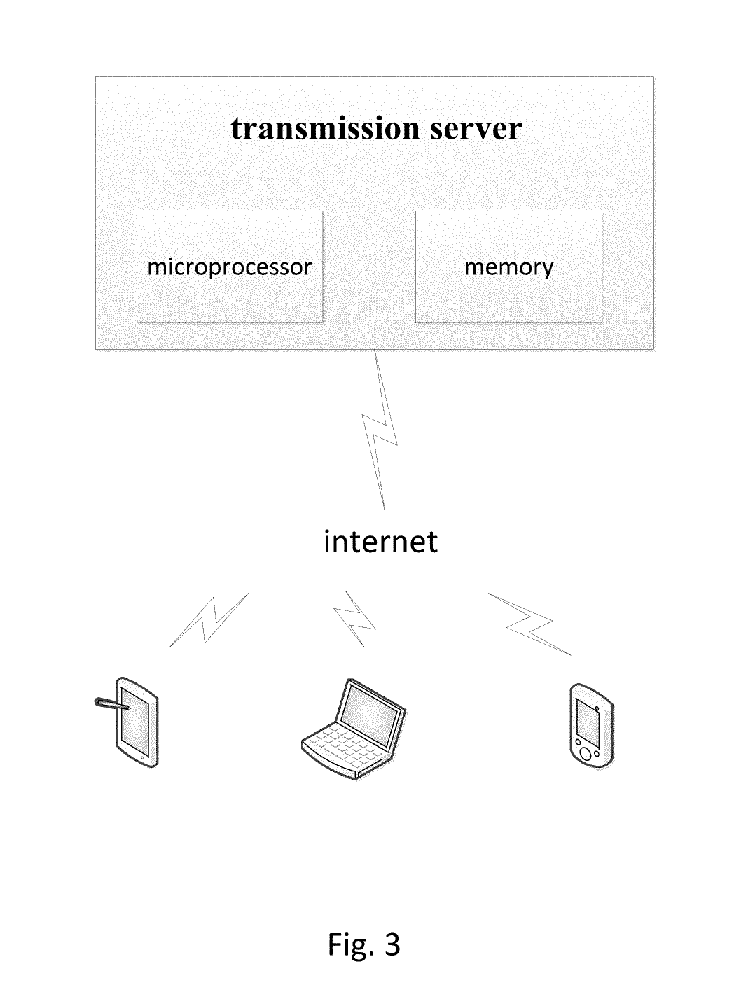

FIG. 1 is a flow chart illustrating a method for crowd funding, in accordance with certain embodiments. FIG. 2 is a block diagram showing a crowd funding platform, in accordance with an example embodiment. FIG. 3 is a block diagram showing how the web/cloud server cooperates with different users, in accordance with certain embodiments.

One skilled in the art will understand that the terms “server”, “web server”, “application server”, and “database server” refer more to the functional aspects offered by components of the system than to physical separation of the underlying computer hardware. For the purpose of this disclosure they are also referred collectively as transmission server. Indeed, in one embodiment, the entire system may be implemented on a single server running all of the software components required to implement the disclosed system. In other embodiments, the disclosed system may run “in the cloud”, or may be architected on a distributed server network. In this embodiment, the web/cloud transmission server includes a microprocessor and a memory for storing information relating to the users. Such as the idea producer, the investors, the manufacturer and the crowd funding platform.

Crowdsourcing is based on performing a task, for example, from the online community. The task may range from generating ideas, raising funds to selling a product or generating content. Crowdsourcing may allow lowering cost for some types of services, increasing quality and available options, implementing innovative ideas, generating content using “crowd wisdom” and in general, change the way of new and innovative products and services are created and delivered to the market.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. The described method is related to crowd fundraising. In the preferred embodiment, the crowd funding method or system is operated on or connected to a crowd fundraising platform. In some embodiment, the disclosed method could be accessible via internet to potential end users. In other embodiment, the method could operate in a local network such as private LAN.

People could sign up for the crowd fundraising platform; one could sign in as an idea provider, a manufacturer or a backer. Unlike traditional crowd fundraising, the users are categorized to different roles. Each account has user profile, which includes information such as user name, posted ideas, funded history, etc. As for the manufacturer's account, the information further includes previous project, company status or website or blog of the company. One could also link their social network account such as Facebook, Twitter or LinkedIn with previous platform.

The average people may have an idea but may not have the ability to bring it to market. Those idea generators and inventors, could publish their ideas on a platform that includes a detailed description, video or graphic representation and if the idea is materialized as a product to collect royalties from the sale once the idea is brought to a customer. The web/cloud server of the present invention could receive information associated with multiple crowdsourcing ideas. Then the web/cloud server could display the multiple crowdsourcing ideas on the crowd funding platform (flow cart of FIG. 1).

In the present invention, the idea provider could earn royalty from the idea turn into a project or service. For example, the idea generator could ask to receive 5% from the gross sale of the product for the first 24 months. The manufacturer could negotiate the royalty with the inventor via the system. In the present invention, the platform would provide a binding document for both to settle the royalty (could be done at the time the manufacturers apply for the idea).

The fundraising project could be a product, a service or a business model. In the present invention, the crowd fundraising platform encourages the idea generators to post ideas in the idea pool in order to find supporters (investors and backers) and potential manufacturers (makers) and entrepreneurs to build the idea for the public (crowd). These ideas could be reviewed on the platform. The idea creator could receive notifications if their idea has entered a funding stage or reached funding threshold, if ready for award or delivery. The user could personalize the notification setting and get the notification at certain stages.

In some embodiments, users could vote and set vote price for the idea, in order to let the idea provider or a potential manufacturer to see how much funding each idea could raise as well as how many people are interested in the idea. In some embodiment, the crowd fundraising platform could carry out a top 100 of the ideas that reach a threshold of funding or funding interest. Once the idea reaches a determined threshold from the crowdsourcing, the crowdsourcing idea could automatically turn into a crowd funding project. In the present invention, the manufacturer should at least reach 200 votes and the funding capital should be reached within 60 days if neither criterion is met, the idea would be dropped and go back to the idea pool.

Other than the traditional crowd fundraising, in the present invention, the server could distribute information associated with the crowd funding project to at least one on the crowd funding platform, wherein one or more manufactures or service providers will be invited to join and bid for the crowd funding project (give promise to make the project). The manufacturers could bid for the project they are interested or capable of working on. Once a manufacturer applies for a project, the manufacturer could present a video and other credentials in order to win the trust of the backers (investors). For instance, previous projects they have accomplished or the LinkedIn profile to promote themselves. Or they can show the previous projects they have made or similar products they have accomplished. These manufacturers could also provide a prototype of the idea to improve their ability to win the project. The backers could vote for the manufacturers (could be more than one manufacturer). The manufacturer that wins the funding or the first to reach the threshold will be granted the project.

Besides, once these ideas are displayed on the platform, they are stored in an idea pool. The idea pool can be accessed from the public or private clients. In some embodiments, the idea pool could only be open to a private platform users, manufacturers and/or VIP users. These ideas would be published with detail description of the idea, like the name of the project, where the product will be explained and the main features listed. In addition, the information could also include the desired percentage of royalty. In the present invention, the platform allows the viewers to write comment on projects, therefore these comments could narrow the idea into a more specific and realistic scope. The main objective of the comment function is to improve and revise the ideas to a more market driven version. In other way of speaking, in the present invention, the idea creator could interact with representatives of his future market.

The present invention comprises an idea voting mechanism. Once the idea pool is generated, users could vote for support and label a price that they likely to pay if the project become funded. This hypothetical value also could help later bidding from the manufacturers to evaluate whether to carry out the idea. The statistics would also be shown to the manufacturers. In present embodiment, the funding share price at the later stage would be the average or median value in this stage.

Then, enters the phrase of selecting manufacturers. Once the idea had reaches a threshold or certain number of votes, as example 200, the idea could start the funding phase and be promoted to the manufacturers. Then, when at least one manufacturer is assigned for the idea, the idea could turn into a project. In this stage, a user (backer) could select a preferred manufacturer. One could vote and back up the preferred manufacturer. Furthermore, a user (backer) could buy additional votes in the project they like. The price of the vote could be the median price or average price based on the previous phrase (user voting phrase). Or in some embodiments, the price of the project or the service would be provided by the manufacturer. In addition, in the present invention, the platform also provides the user (backer) and the inventor with ability to leave messages to the manufacturers.

For instance, if there are five ideas in the idea pool. These five ideas are provided by five different idea providers and assigned to be released to all users of the crowd fundraising platform. Every user could browse each idea and may send emails or leave messages to the idea providers. Ones the idea arouses interest among the users, and reaches as example 200 interests/likes/votes within X amount of days as example 7 days the idea is ready for funding. And the average price the users would likely pay is calculated based on the median or average vote price as example 10 or 100 USD for the product. In this case, this idea could be promoted to at least one manufacturer if any manufacturer is assigned for the products. This idea could turn into a project or concept and move on to the next stage. Then the user could vote for their preferred manufacturers, each vote could be purchased for either 10 or 100USD. If the manufacturers think 100 USD is not realistic, they could offer a realistic cost for a product or vote. In some circumstance manufacturer A offers 120 USD in order to carry out the product or the service. Manufacturers B offer 100 USD. If one selects manufacture A, one should pay 120 USD for voting, but only need to pay 100USD for choosing manufactures B. The manufacturer that reaches the threshold would win or own the project.

In the above said stage, the manufacturer could ask the crowd to give opinion on the project, such as desired features to add, or desired color or kit, etc. Also, the manufacturer could also ask the idea provider for assistance. Some idea provider may be lacking manufacture experience, but may be an expert in another field that is related to the idea.

In some embodiments, if no manufacturers are elected due the funding did not reach the threshold, then the voted users (backers) would receive a refund. In this embodiment, the selecting manufacturer phrase is time-limited. In previous embodiment, the selecting phrase would be set for 30 days, but not limited to 30 days. One might change the time table according to different circumstances. When the users click vote button on the screen, a request would be sent to the server and it stands for the commitment to purchase the product or the service. The crowd fundraising platform would require an agreement with the user every time the user funds a project.

In previous invention, when the manufacturer applies to bid or compete for an idea, the manufacturer has to pay an application fee to the crowd fundraising platform. If the manufacture applied in the early stage, such as applied for an idea before the idea reached a threshold or certain number of votes, the application fee is relatively lower and be calculated based on the stage the project is funded. Since if the manufacturer is applied in an early stage it brings higher risk to the manufacturer and more security to the project. This strategy could encourage the manufacturers to participate in an early stage.

For example, if an idea achieves 30 backers, with vote price of 100 USD, the estimated raised capital is 3,000 USD, if a manufacture decides to build this project in this stage (30 backers), the application fee would be 60 USD. When the votes achieve 250 backers (estimated raised capital may be 45,000 USD), then the application fee would be 900 USD if the manufacturer decide to apply for this project at this time. In this embodiment, the application fee is 2% of the arising capital, but in other embodiment, the application fee could be a fixed fee.

In addition, in the present invention, the crowd fundraising platform further comprises a background check of the manufacturers. In other way of speaking, the platform would research the manufacturers in order to mitigate the risk of failure of the project and protect the users backing the idea.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A computer-implemented method for crowd fundraising, comprising:
accessing, via a computer network, a transmission server of a crowd funding platform, wherein the said transmission server is comprising a microprocessor and memory to store user information, wherein said microprocessor is receiving information associated with multiple crowdsourcing ideas;
displaying the multiple crowdsourcing ideas on the crowd funding platform, wherein if the crowdsourcing idea reaches a determined threshold of the crowdsourcing, the crowdsourcing idea automatically turns into a crowd funding project;
distributing information associated with said crowd funding project to at least one on said crowd funding platform, wherein one or more manufacturers or service providers are invited to join and make the product idea submitted in said crowd funding platform;
assigning at least one manufacturer or service provider for the project;
receiving funding from one or more contributions associated with the crowd funding project;
calculating a total amount of the one or more of contributions;
determining that said total amount is equal to or exceeds a determined threshold; and
calculating said total amount that needs to transfer to manufacture or service provider.

2. The method of claim 1, wherein said microprocessor;
determining that one or more manufactures or service providers are qualified or permitted to be assigned to a project.

3. The method of claim 1, wherein said microprocessor is storing data in said memory based on received response from an investment activities.

4. The method of claim 1, wherein said microprocessor is
providing at least one progress update of a project, at least one progress update is generated by a log from each stage of said progress update.

5. The method of claim 1, wherein said microprocessor is
receiving user commitments for assigning a manufacture or service provider for a project, wherein if a commitment does not reach a determined threshold, said project will not move on.

6. The method of claim 1, wherein a user could purchase additional commitment or vote for assigning a manufacturer or service provider for a project.

7. The method of claim 1, wherein said microprocessor further comprises an algorithm for gathering an estimated price information of said crowd funding project from participated users.

8. The method of claim 7, wherein said estimated price of a crowd funding project is an average of said gathered estimated price.

9. The method of claim 7, wherein said gathered estimated price is a median price of said estimated price provided by participated users.

10. The method of claim 1, wherein said microprocessor further comprises an algorithm for a decision of transferring a total amount of funds to one manufacture or service provider.

11. The method of claim 1, wherein each of one or more users, inventors and/or manufacturers receive a share of said crowd funding project.
